(19) United States
(12) Patent Application Publication
(10) Pub. No.: US 2024/0126076 A1
(43) Pub. Date: Apr. 18, 2024

(54) HEAD-UP DISPLAY DEVICE

(71) Applicant: YAZAKI CORPORATION, Tokyo (JP)

(72) Inventors: Yusuke Sugiura, Makinohara-shi (JP); Akira Yamanaka, Makinohara-shi (JP); Yuta Miyake, Makinohara-shi (JP); Naohisa Murata, Makinohara-shi (JP); Hiroshi Sano, Makinohara-shi (JP)

(21) Appl. No.: 18/398,148

(22) Filed: Dec. 28, 2023

Related U.S. Application Data
(63) Continuation of application No. PCT/JP2022/045853, filed on Dec. 13, 2022.

(30) Foreign Application Priority Data
Dec. 14, 2021 (JP) 2021-202513

(51) Int. Cl. G02B 27/01

(52) U.S. Cl. CPC G02B 27/0101; G02B 2027/014; G02B 2027/0154

(57) ABSTRACT

A head-up display device includes: an indicator dimmed by duty ratio control and configured to emit display light; a mirror member rotatable about a rotation shaft and configured to reflect the display light from the indicator to project a display image; a control unit configured to control the dimming of the indicator and the rotation of the mirror member; and a temperature sensor configured to output a signal corresponding to an ambient temperature around the indicator. The control unit includes: a temperature prediction unit configured to predict a temperature of the indicator, and a failure avoidance unit configured to execute lowering an upper limit of the duty ratio or rotation control of the mirror member for reducing the amount of sunlight that enters the indicator through the mirror member when the predicted temperature of the indicator is greater than or equal to a threshold.

### CROSS-REFERENCE TO RELATED APPLICATIONS

This is a continuation of International Application No. PCT/JP2022/045853 filed on Dec. 13, 2022, and claims priority from Japanese Patent Application No. 2021-202513 filed on Dec. 14, 2021, the entire content of which is incorporated herein by reference.

### TECHNICAL FIELD

The present invention relates to a head-up display device.

### BACKGROUND ART

In the related art, there is known a head-up display device that includes, in an opening formed in an upper face of an instrument panel, an indicator and a mirror that reflects an image displayed on the indicator toward a windshield (for example, see JP6107380B).

### SUMMARY OF INVENTION

Here, in the head-up display device described in JP6107380B, the sunlight may enter the indicator through the mirror, and in this case, the indicator may be heated and fail. Therefore, when a temperature of the indicator is high, it is conceivable to perform failure avoidance control such as lowering a duty ratio for controlling energization of a backlight constituting the indicator.

However, since the temperature of the indicator in the head-up display device is unknown, the failure avoidance control cannot be performed at an appropriate timing. Therefore, even if a temperature sensor is provided on the indicator, the temperature sensor can only be installed at a position where the temperature sensor does not interfere with display light from the indicator, that is, outside a path of the display light, and it is difficult to accurately detect the temperature of the indicator. As a result, the failure avoidance control may be performed when the temperature of the indicator does not become high enough, or the failure avoidance control may not be executed even though the temperature of the indicator is extremely high.

Aspect of non-limiting embodiments of the present disclosure relates to provide a head-up display device capable of performing failure avoidance control at a more appropriate timing.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a head-up display device including:
an indicator dimmed by duty ratio control and configured to emit display light;
a mirror member rotatable about a rotation shaft and configured to reflect the display light from the indicator to project a display image;
a control unit configured to control the dimming of the indicator by the duty ratio control and control the rotation of the mirror member; and
a temperature sensor provided outside a path of the display light emitted from the indicator and configured to output a signal corresponding to an ambient temperature around the indicator, wherein
the control unit includes:
   a temperature prediction unit configured to predict, based on a duty ratio of the indicator and the ambient temperature based on the signal from the temperature sensor, a temperature of the indicator, and
   a failure avoidance unit configured to execute, as failure avoidance control, at least one of lowering control for lowering an upper limit of the duty ratio of the indicator or rotation control of the mirror member for reducing the amount of sunlight that enters the indicator through the mirror member when the temperature of the indicator predicted by the temperature prediction unit is greater than or equal to a threshold, wherein
when the temperature of the indicator predicted by the temperature prediction unit is greater than or equal to the threshold, the failure avoidance unit lowers the upper limit of the duty ratio of the indicator as the temperature of the indicator increases.

### BRIEF DESCRIPTION OF DRAWINGS

Exemplary embodiment(s) of the present invention will be described in detail based on the following figures, wherein:

FIG. 1 is a schematic side view showing a head-up display device according to a first embodiment of the present invention;

FIG. 2 is a schematic side view showing main parts of the head-up display device according to the first embodiment of the present invention;

FIG. 3 is a correlation diagram showing a correlation between a temperature and an upper limit of a duty ratio of an indicator;

FIG. 4 is a flowchart showing an operation of the head-up display device according to the first embodiment, and shows processing related to failure avoidance control;

FIG. 5 is a flowchart showing an operation of the head-up display device according to the first embodiment, and shows processing related to restriction release control;

FIG. 6 is a correlation diagram showing a correlation between a temperature and an upper limit of a duty ratio of an indicator according to a second embodiment;

FIG. 7 is a flowchart showing an operation of a head-up display device according to the second embodiment, and shows processing related to failure avoidance control;

FIG. 8 is a correlation diagram showing a correlation between a temperature and an upper limit of a duty ratio of an indicator according to a third embodiment; and

FIG. 9 is a flowchart showing an operation of a head-up display device according to the third embodiment, and shows processing related to restriction release control.

### DESCRIPTION OF EMBODIMENTS

Hereinafter, the present invention will be described with reference to preferred embodiments. The present invention is not limited to the following embodiments, and can be appropriately modified without departing from the scope of the present invention. In addition, in the embodiments described below, although there are portions in which illustrations and descriptions of some configurations are omitted, it goes without saying that for details of omitted techniques, publicly known or well-known techniques are appropriately applied within a range that does not cause contradiction with contents described below.

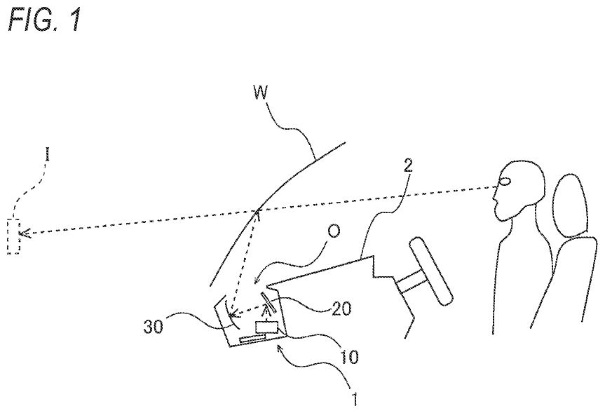

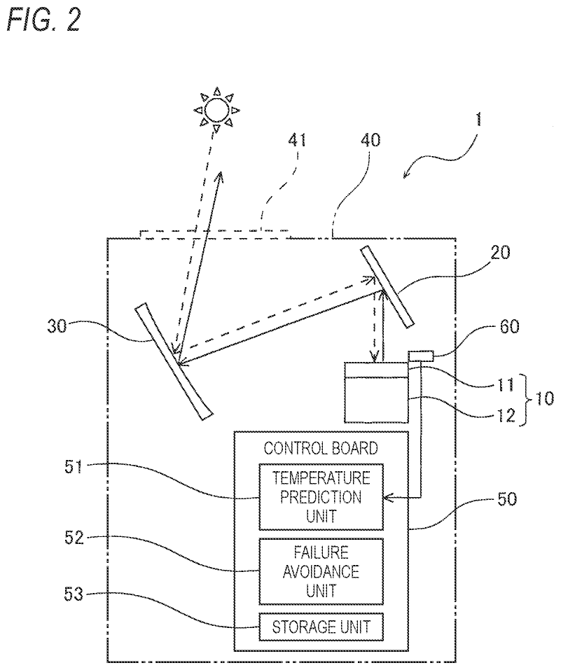

FIG. 1 is a schematic side view showing a head-up display device according to a first embodiment of the present invention, and FIG. 2 is a schematic side view showing main parts of the head-up display device according to the first embodiment of the present invention.

As shown in FIG. 1, a head-up display device 1 according to the first embodiment is housed in an opening O formed in an upper face of an instrument panel 2 of a vehicle. As shown in FIGS. 1 and 2, the head-up display device 1 includes an indicator 10, a reflecting mirror 20, a concave mirror (mirror member) 30, a housing 40, a control board (control unit) 50, and a temperature sensor 60.

The indicator 10 is a liquid crystal display including a liquid crystal panel 11 and a backlight 12 behind the liquid crystal panel 11, and is dimmed by controlling the brightness of the backlight 12 by duty ratio control. The indicator 10 emits information to be provided to a driver as display light. The display light from the indicator 10 is emitted toward the reflecting mirror 20 shown in FIGS. 1 and 2, and is reflected by the reflecting mirror 20 toward the concave mirror 30.

The concave mirror 30 reflects the display light and projects a display image onto a windshield W of the vehicle via a cover member 41 of the housing 40. The display image projected onto the windshield W is recognized by the driver as a virtual image I. The concave mirror 30 is rotatable about a rotation shaft. The concave mirror 30 controls a height of the virtual image I that is visually recognized by the driver by rotating about the rotation shaft.

The control board 50 controls the entire head-up display device 1, and in particular, in the present embodiment, the control board 50 has a function of performing dimming control of the indicator 10 by the duty ratio control and controlling the rotation of the concave mirror 30. The temperature sensor 60 is provided outside a path of the display light emitted from the indicator 10, and outputs a signal corresponding to an ambient temperature around the indicator 10. The temperature sensor 60 includes a thermistor and transmits the signal corresponding to the ambient temperature to the control board 50.

The control board 50 further includes a temperature prediction unit 51, a failure avoidance unit 52, and a storage unit 53. The temperature prediction unit 51 predicts a temperature of the indicator 10. The temperature prediction unit 51 predicts the temperature of the indicator 10 based on a duty ratio of the indicator 10 and the ambient temperature around the indicator 10 based on the signal from the temperature sensor 60.

Here, the storage unit 53 stores a temperature rise value for each duty ratio of the indicator 10. Therefore, the temperature prediction unit 51 predicts the temperature of the indicator 10 by adding the temperature rise value corresponding to the current duty ratio to the ambient temperature detected by the temperature sensor 60.

When the temperature of the indicator 10 predicted by the temperature prediction unit 51 is greater than or equal to a threshold, the failure avoidance unit 52 executes failure avoidance control to prevent a failure of the indicator 10. The failure avoidance control is at least one of lowering control for lowering an upper limit of the duty ratio of the indicator 10 or rotation control of the concave mirror 30 for reducing the amount of sunlight that enters the indicator 10 through the concave mirror 30.

More specifically, when the temperature of the indicator 10 predicted by the temperature prediction unit 51 is greater than or equal to the threshold, the failure avoidance unit 52 lowers the upper limit of the duty ratio of the indicator 10 as the temperature of the indicator 10 increases.

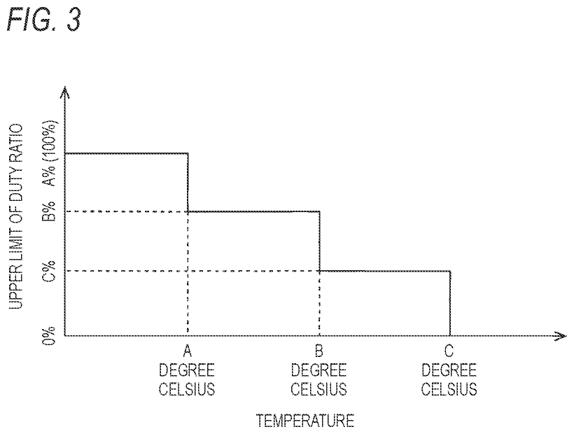

FIG. 3 is a correlation diagram showing a correlation between the temperature and the upper limit of the duty ratio of the indicator 10. As shown in FIG. 3, the failure avoidance unit 52 according to the first embodiment sets the upper limit of the duty ratio to A % when the temperature of the indicator 10 is less than A degree Celsius (threshold). A % is an initial value, and is, for example, 100%. When the temperature of the indicator 10 is greater than or equal to A degree Celsius (threshold) and less than B degree Celsius, the failure avoidance unit 52 lowers the upper limit of the duty ratio to B % A %). When the temperature of the indicator 10 is greater than or equal to B degree Celsius and less than C degree Celsius (specified value), the failure avoidance unit 52 lowers the upper limit of the duty ratio to C % (<B %).

Further, when the temperature of the indicator 10 is greater than or equal to C degree Celsius (specified value), the failure avoidance unit 52 lowers the upper limit of the duty ratio to 0%. That is, the failure avoidance unit 52 turns off the indicator 10.

Refer to FIG. 2 again. Further, when the temperature of the indicator 10 is greater than or equal to C degree Celsius (specified value), the failure avoidance unit 52 according to the present embodiment rotates the concave mirror 30 to a parking position (hereinafter, referred to as a PP position) where the amount of sunlight that enters the indicator 10 through the concave mirror 30 is less than or equal to a predetermined amount of light. The PP position is an example of a first rotation angle. Here, the predetermined amount of light refers to the amount of light that can maintain the indicator 10 at a temperature less than a failure temperature in a case where a temperature of the upper face of the instrument panel 2 rises to about 80 degrees in summer or the like. In the above case, the predetermined amount of light is preferably the amount of light that can maintain the indicator 10 at a temperature less than a guaranteed temperature. Further, the predetermined amount of light is more preferably zero amount of light. In the present embodiment, the PP position is assumed to be an angle at which the amount of light is zero. Here, the amount of sunlight refers to the amount of direct light from the sun that passes through the windshield W, is reflected by the concave mirror 30 and the reflecting mirror 20, and enters the indicator 10. Therefore, the amount of sunlight does not include the amount of diffusely reflected light that is reflected by, for example, a building outside the vehicle or an inner surface of the housing 40 of the head-up display device 1 and enters the indicator 10.

In a case where the temperature of the indicator 10 is greater than or equal to C degree Celsius, the indicator 10 is turned off, and the concave mirror 30 is controlled to rotate to the PP position, when the temperature of the indicator 10 predicted by the temperature prediction unit 51 is less than C degree Celsius, the failure avoidance unit 52 executes restriction release control. The restriction release control is control for turning on the indicator 10 and returning the concave mirror 30 to a rotation position (second rotation angle) before the concave mirror is set to the PP position.

In particular, when the temperature of the indicator 10 predicted by the temperature prediction unit 51 is less than C degree Celsius and the restriction release control is executed, the failure avoidance unit 52 increases the upper limit of the duty ratio of the indicator 10 as the temperature of the indicator 10 predicted by the temperature prediction unit 51 is lower.

Refer to FIG. 3. When the temperature of the indicator 10 is greater than or equal to C degree Celsius (specified value), the failure avoidance unit 52 according to the present embodiment lowers the upper limit of the duty ratio to 0%. In this state, when the temperature of the indicator 10 is greater than or equal to B degree Celsius and less than C degree Celsius, the failure avoidance unit 52 increases the upper limit of the duty ratio to C %. When the temperature of the indicator 10 is greater than or equal to A degree Celsius and less than B degree Celsius, the failure avoidance unit 52 increases the upper limit of the duty ratio to B %.

Further, when the temperature of the indicator 10 is less than A degree Celsius (threshold), the failure avoidance unit 52 increases the upper limit of the duty ratio to A %. That is, the failure avoidance unit 52 returns the upper limit of the duty ratio to the state before the failure avoidance control is executed.

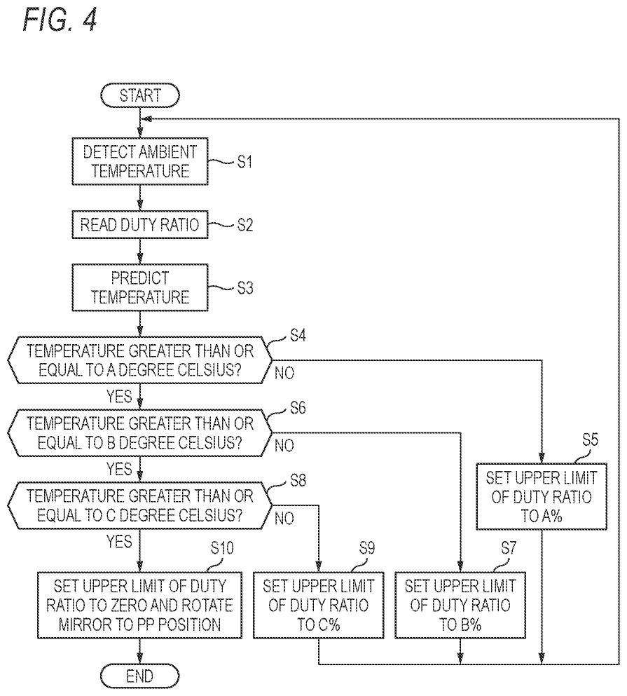

Next, an operation of the head-up display device 1 according to the first embodiment will be described. FIG. 4 is a flowchart showing the operation of the head-up display device 1 according to the first embodiment, and shows processing related to the failure avoidance control.

As shown in FIG. 4, first, the temperature prediction unit 51 detects the ambient temperature around the indicator 10 based on the signal from the temperature sensor 60 (S1). Next, the temperature prediction unit 51 reads the current duty ratio of the indicator 10 (S2). Next, the temperature prediction unit 51 obtains the temperature rise value from the duty ratio read in step S2, and adds the temperature rise value to the ambient temperature detected in step S1 to predict the temperature of the indicator 10 (S3).

Next, the failure avoidance unit 52 determines whether the temperature of the indicator 10 is greater than or equal to A degree Celsius (S4). When the temperature of the indicator 10 is not greater than or equal to A degree Celsius (S4: NO), the failure avoidance unit 52 sets the upper limit of the duty ratio to A % (S5). Thereafter, the process proceeds to step S1.

On the other hand, when the temperature of the indicator 10 is greater than or equal to A degree Celsius (S4: YES), the failure avoidance unit 52 determines whether the temperature of the indicator 10 is greater than or equal to B degree Celsius (S6). When the temperature of the indicator 10 is not greater than or equal to B degree Celsius (S6: NO), the failure avoidance unit 52 sets the upper limit of the duty ratio to B % (S7). Thereafter, the process proceeds to step S1.

When the temperature of the indicator 10 is greater than or equal to B degree Celsius (S6: YES), the failure avoidance unit 52 determines whether the temperature of the indicator is greater than or equal to C degree Celsius (S8). When the temperature of the indicator 10 is not greater than or equal to C degree Celsius (S8: NO), the failure avoidance unit 52 sets the upper limit of the duty ratio to C % (S9). Thereafter, the process proceeds to step S1.

When the temperature of the indicator 10 is greater than or equal to C degree Celsius (S8: YES), the failure avoidance unit 52 sets the upper limit of the duty ratio to zero and rotates the concave mirror 30 to the PP position so that the sunlight does not enter the indicator 10 (S10). Thereafter, the process shown in FIG. 4 ends.

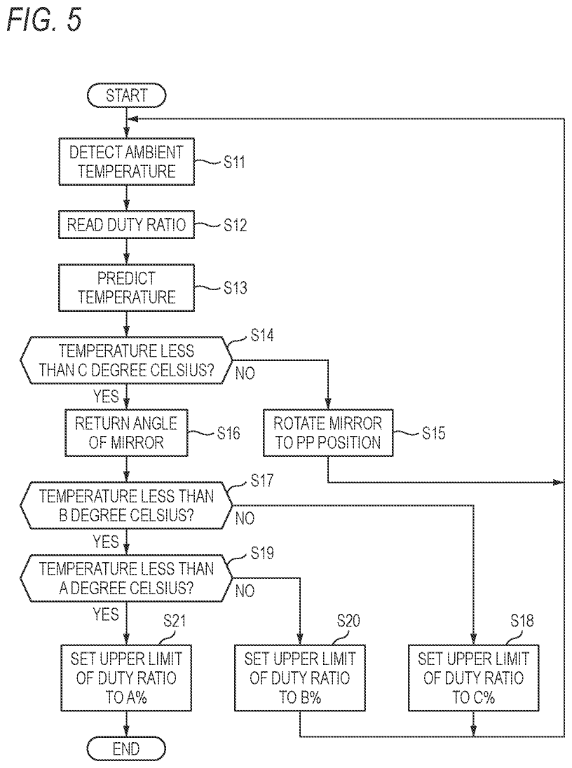

FIG. 5 is a flowchart showing an operation of the head-up display device 1 according to the first embodiment, and shows processing related to the restriction release control. First, in the processing of steps S11 to S13 shown in FIG. 5, the same processing as steps S1 to S3 shown in FIG. 4 is performed.

Thereafter, the failure avoidance unit 52 determines whether the predicted temperature of the indicator 10 is less than C degree Celsius (S14). When the temperature of the indicator 10 is not less than C degree Celsius (S14: NO), the failure avoidance unit 52 sets the concave mirror 30 to the PP position (S15). Thereafter, the process proceeds to step S11.

On the other hand, when the temperature of the indicator 10 is less than C degree Celsius (S14: YES), the failure avoidance unit 52 returns the angle of the concave mirror 30 to the original angle position (S16). Next, the failure avoidance unit 52 determines whether the temperature of the indicator 10 is less than B degree Celsius (S17). When the temperature of the indicator 10 is not less than B degree Celsius (S17: NO), the failure avoidance unit 52 sets the upper limit of the duty ratio to C % (S18). Thereafter, the process proceeds to step S11.

When the temperature of the indicator 10 is less than B degree Celsius (S17: YES), the failure avoidance unit 52 determines whether the temperature of the indicator 10 is less than A degree Celsius (S19). When the temperature of the indicator 10 is not less than A degree Celsius (S19: NO), the failure avoidance unit 52 sets the upper limit of the duty ratio to B % (S20). Thereafter, the process proceeds to step S11.

When the temperature of the indicator 10 is less than A degree Celsius (S19: YES), the failure avoidance unit 52 sets the upper limit of the duty ratio to A % (S21). Thereafter, the processing shown in FIG. 5 ends.

In this way, according to the head-up display device 1 according to the present embodiment, the temperature of the indicator 10 is predicted based on the duty ratio of the indicator 10 and the ambient temperature based on the signal from the temperature sensor 60. Here, in the head-up display device 1, although the temperature sensor 60 can only be provided outside the path of the display light, making it difficult to accurately measure the temperature of the indicator 10, by considering the duty ratio that contributes to heat generation of the indicator 10, the temperature of the indicator 10 can be predicted more accurately. Then, by executing the failure avoidance control when the predicted temperature of the indicator 10 is greater than or equal to A degree Celsius, it is possible to provide the head-up display device 1 capable of performing the failure avoidance control more appropriately.

When the temperature of the indicator 10 is greater than or equal to A degree Celsius, the upper limit of the duty ratio of the indicator 10 is lowered as the temperature of the indicator increases. Therefore, when the temperature is greater than or equal to A degree Celsius but not extremely high, the degree of restriction of the duty ratio is small, and it is possible to prevent the display light from becoming too dark.

When the predicted temperature of the indicator 10 is greater than or equal to C degree Celsius, the indicator 10 is turned off, and the concave mirror 30 is rotated to the PP position to make the amount of sunlight that reaches the indicator 10 through the concave mirror less than or equal to the predetermined amount of light, for example, to make the amount of direct light zero. Therefore, when the temperature of the indicator 10 is extremely high, the indicator 10 is turned off and the entering sunlight is restricted to less than or equal to the predetermined amount of light from the viewpoint of emergency failure avoidance, making it even easier to avoid a failure.

In addition, in a case where the indicator 10 is turned off and the entering sunlight is restricted to less than or equal to the predetermined amount of light, when the temperature of the indicator 10 is less than C degree Celsius, the restriction release control is executed to turn on the indicator 10 and return the concave mirror 30 to the rotation angle before the concave mirror 30 is set to the PP position. Therefore, when the temperature of the indicator 10 decreases to less than C degree Celsius, the restriction is released, and for example, the virtual image display is restarted at an early stage without waiting for the temperature to decrease to less than A degree Celsius, and the usability of the head-up display device 1 can be improved.

In addition, when the predicted temperature of the indicator 10 is less than C degree Celsius and the indicator 10 is turned on, the upper limit of the duty ratio of the indicator 10 is increased as the predicted temperature of the indicator 10 is lower. Therefore, even in a case where the restriction is released, when the temperature is not extremely high, the degree of restriction of the duty ratio is small, and it is possible to prevent the display light from becoming too dark.

Next, a second embodiment of the present invention will be described. The head-up display device 1 according to the second embodiment is similar to that according to the first embodiment, but some processes are different. Hereinafter, differences from the first embodiment will be described.

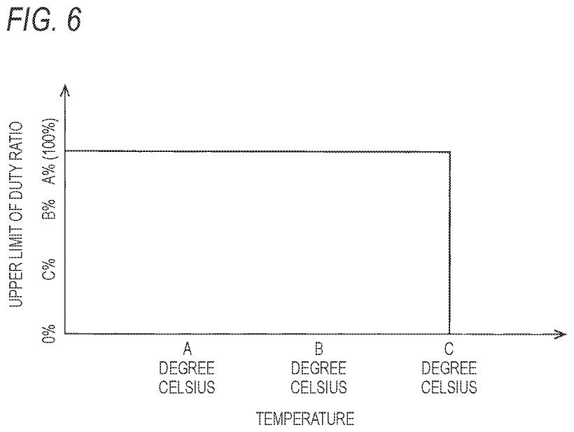

FIG. 6 is a correlation diagram showing a correlation between a temperature and an upper limit of a duty ratio of the indicator 10 according to the second embodiment. As shown in FIG. 6, in the second embodiment, the failure avoidance unit 52 does not lower the upper limit of the duty ratio even when the predicted temperature of the indicator 10 is greater than or equal to A degree Celsius, and when the predicted temperature of the indicator 10 is greater than or equal to C degree Celsius, which is a threshold in the second embodiment, the failure avoidance unit 52 lowers the duty ratio of the indicator 10 to zero to turn off the indicator 10. The second embodiment is similar to the first embodiment in that the concave mirror 30 is set to a PP position when the temperature of the indicator 10 is greater than or equal to C degree Celsius.

As described above, in the second embodiment, failure avoidance control is not executed even when the predicted temperature of the indicator 10 is greater than or equal to A degree Celsius, and the failure avoidance control is executed when the temperature is C degree Celsius, which is higher than A degree Celsius. That is, in the second embodiment, no failure avoidance control is performed when the temperature is less than C degree Celsius, and the indicator 10 is turned off when the temperature reaches C degree Celsius, that is, control of setting the duty ratio to zero and setting the concave mirror 30 to the PP position is executed at once. Therefore, even when the temperature of the indicator 10 increases to a certain extent, the failure avoidance control is executed to prevent a failure that may occur while ensuring the visibility without darkening the indicator 10, and the failure can be avoided while ensuring the visibility as much as possible.

In the second embodiment, it is assumed that the failure avoidance unit 52 performs the same restriction release control as in the first embodiment, but the present invention is not limited thereto, and when the predicted temperature of the indicator 10 changes from greater than or equal to C degree Celsius to less than C degree Celsius, the failure avoidance unit 52 may increase the upper limit of the duty ratio to A % at once according to the correlation diagram shown in FIG. 6.

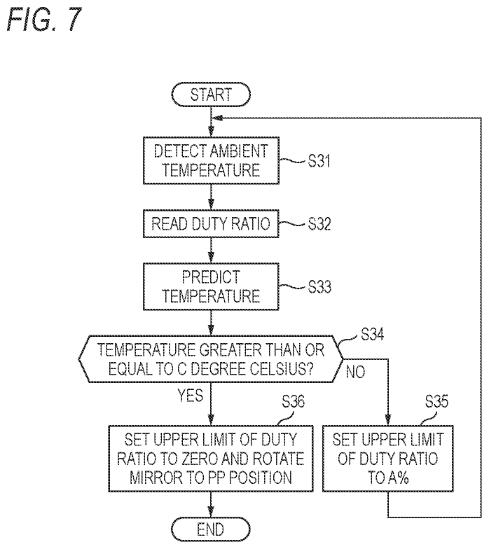

FIG. 7 is a flowchart showing an operation of the head-up display device 1 according to the second embodiment, and shows processing related to the failure avoidance control. First, in steps S31 to S33 shown in FIG. 7, the same processing as steps S1 to S3 shown in FIG. 4 is executed.

Next, in step S34 shown in FIG. 7, the failure avoidance unit 52 determines whether the temperature of the indicator 10 is greater than or equal to C degree Celsius (S34). When the temperature of the indicator 10 is not greater than or equal to C degree Celsius (S34: NO), the failure avoidance unit 52 sets the upper limit of the duty ratio to A % (S35). Thereafter, the process proceeds to step S31.

When the temperature of the indicator 10 is greater than or equal to C degree Celsius (S34: YES), the failure avoidance unit 52 sets the upper limit of the duty ratio to zero and rotates the concave mirror 30 to the PP position so that sunlight does not enter the indicator 10 (S36). Thereafter, the processing shown in FIG. 7 ends.

In this way, according to the head-up display device 1 of the second embodiment, the same effects as those of the first embodiment can be obtained.

In addition, according to the second embodiment, the failure avoidance control is not executed even when the predicted temperature of the indicator 10 is greater than or equal to A degree Celsius, and the failure avoidance control is executed when the temperature is greater than or equal to C degree Celsius, which is higher than A degree Celsius. Therefore, even when the temperature of the indicator 10 increases to a certain extent, the failure avoidance control is executed to prevent a failure that may occur while ensuring the visibility without darkening the indicator 10, and the failure can be avoided while ensuring the visibility as much as possible.

Next, a third embodiment of the present invention will be described. The head-up display device 1 according to the third embodiment is similar to that according to the first embodiment, but some processes are different. Hereinafter, differences from the first embodiment will be described.

First, even when the predicted temperature of the indicator 10 is greater than or equal to C degree Celsius and then less than C degree Celsius, the head-up display device 1 according to the third embodiment returns the concave mirror 30 to a second rotation angle without turning on the indicator 10.

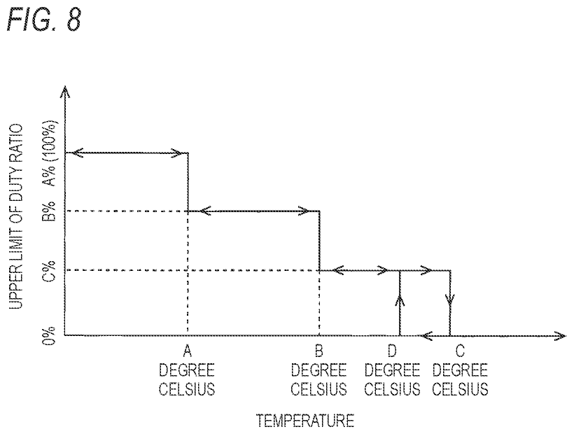

FIG. 8 is a correlation diagram showing a correlation between the temperature and an upper limit of a duty ratio of the indicator 10 according to the third embodiment. As shown in FIG. 8, in the third embodiment, the failure avoidance unit 52 lowers the upper limit of the duty ratio each time the predicted temperature of the indicator 10 reaches A degree Celsius (threshold) and B degree Celsius, and lowers the duty ratio of the indicator 10 to zero to turn off the indicator 10 when the predicted temperature of the indicator 10 is greater than or equal to C degree Celsius (specified value).

In the third embodiment, even when the predicted temperature of the indicator 10 decreases from greater than or equal to C degree Celsius to less than C degree Celsius, the failure avoidance unit 52 maintains the upper limit of the duty ratio at zero until the predicted temperature of the indicator 10 reaches D degree Celsius (specific value). That is, even when the predicted temperature of the indicator 10 decreases from greater than or equal to C degree Celsius to less than C degree Celsius, the failure avoidance unit 52 according to the third embodiment returns the concave mirror 30 to the original rotation angle (second rotation angle) without turning on the indicator 10.

Thereafter, when the predicted temperature of the indicator 10 decreases to less than D degree Celsius, the failure avoidance unit 52 increases the upper limit of the duty ratio to C % to turn on the indicator 10, and increases the upper limit of the duty ratio to B % and A % each time the temperature reaches B degree Celsius and A degree Celsius from then on.

As described above, in the third embodiment, the concave mirror 30 is returned before the indicator 10 is turned on. Here, when the concave mirror 30 is returned, sunlight exceeding a predetermined amount of light may enter the indicator 10. Therefore, the temperature of the indicator 10 may be greater than or equal to C degree Celsius again. Therefore, the predicted temperature of the indicator 10 may change back and forth several times around C degree Celsius. In such a case, in the first embodiment, the indicator 10 may be repeatedly turned on and off, but in the third embodiment, since the indicator 10 is turned on when the temperature of the indicator 10 is less than D degree Celsius, such a situation can be avoided. Therefore, it is possible to prevent the indicator 10 from being repeatedly turned on and off. In the above description, the indicator 10 is turned on when the predicted temperature of the indicator 10 decreases to less than D degree Celsius, but the timing at which the indicator 10 is turned on is not limited to the timing at which the predicted temperature of the indicator 10 is less than D degree Celsius, and may be, for example, the timing at which the predicted temperature of the indicator 10 is less than A degree Celsius.

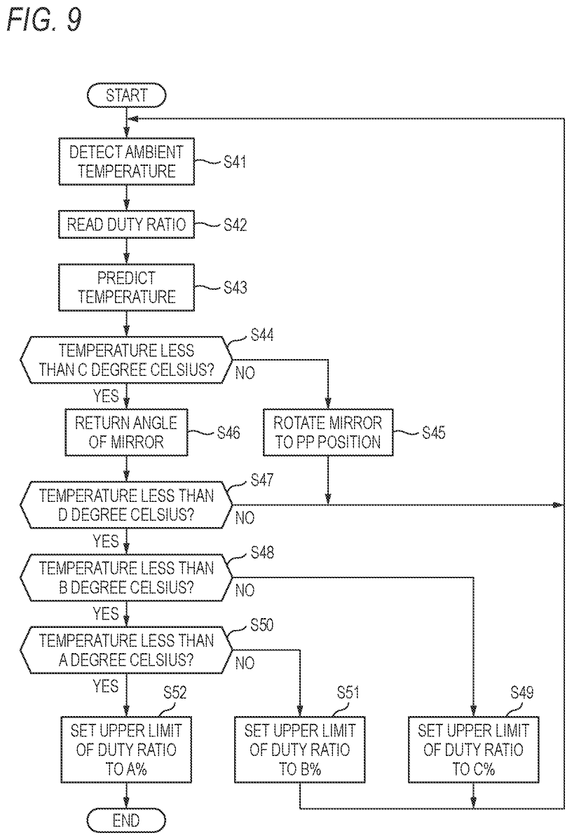

FIG. 9 is a flowchart showing an operation of the head-up display device 1 according to the third embodiment, and shows processing related to restriction release control. First, in steps S41 to S46 shown in FIG. 9, the same processing as steps S11 to S16 shown in FIG. 5 is executed.

Next, in step S47 shown in FIG. 9, the failure avoidance unit 52 determines whether the temperature of the indicator 10 is less than D degree Celsius (S47). When the temperature of the indicator 10 is not less than D degree Celsius (S47: NO), the process proceeds to step S41.

When the temperature of the indicator 10 is less than D degree Celsius (S47: YES), the failure avoidance unit 52 determines whether the temperature of the indicator 10 is less than B degree Celsius (S48). When the temperature of the indicator 10 is not less than B degree Celsius (S48: NO), the failure avoidance unit 52 sets the upper limit of the duty ratio to C % (S49). Thereafter, the process proceeds to step S41.

When the temperature of the indicator 10 is less than B degree Celsius (S48: YES), the failure avoidance unit 52 determines whether the temperature of the indicator 10 is less than A degree Celsius (S50). When the temperature of the indicator 10 is not less than A degree Celsius (S50: NO), the failure avoidance unit 52 sets the upper limit of the duty ratio to B % (S51). Thereafter, the process proceeds to step S41.

When the temperature of the indicator 10 is less than A degree Celsius (S50: YES), the failure avoidance unit 52 sets the upper limit of the duty ratio to A % (S52). Thereafter, the processing shown in FIG. 9 ends.

In this way, according to the head-up display device 1 of the third embodiment, the same effects as those of the first embodiment can be obtained.

In addition, according to the third embodiment, the concave mirror 30 is returned when the predicted temperature of the indicator 10 is less than C degree Celsius, and the indicator 10 is turned on when the temperature of the indicator 10 is less than D degree Celsius. Here, when the concave mirror 30 is returned, sunlight exceeding a predetermined amount of light may enter the indicator 10. Therefore, the temperature of the indicator 10 may rise to greater than or equal to C degree Celsius again. Therefore, the predicted temperature of the indicator 10 may change back and forth several times around C degree Celsius. In such a case, in the first embodiment, the indicator 10 may be repeatedly turned on and off, but in the third embodiment, since the indicator 10 is turned on when the temperature of the indicator 10 is less than D degree Celsius, such a situation can be avoided. Therefore, it is possible to prevent the indicator 10 from being repeatedly turned on and off.

Although the present invention has been described above based on the embodiments, the present invention is not limited to the embodiments described above, and modifications may be made without departing from the gist of the present invention, or publicly known or well-known techniques may be appropriately combined.

For example, in the present embodiment, the temperature prediction unit 51 predicts the temperature of the indicator 10 based on an ambient temperature and a temperature rise value obtained from the duty ratio, but the present invention is not limited thereto, and for example, a heat generation amount may be obtained based on the duty ratio and a lighting time, and the temperature rise value based on the heat generation amount may be calculated and added to the ambient temperature. This is because as a result, the temperature prediction is performed in consideration of the heat generation amount, and the temperature prediction can be performed more accurately.

In the above embodiments, the failure avoidance unit 52 sets the concave mirror 30 at the PP position when the temperature of the indicator 10 is greater than or equal to C degree Celsius, but the failure avoidance unit 52 may set the concave mirror 30 at another rotation position instead of the PP position to reduce the amount of entering sunlight or limit the amount of entering sunlight to less than or equal to a predetermined amount of light, particularly zero. That is, the first rotation angle is not limited to the PP position.

In addition, the failure avoidance unit 52 may control the rotation angle of the concave mirror 30 such that the amount of entering sunlight reaching the indicator 10 decreases as the temperature of the indicator 10 increases. At this time, the failure avoidance unit 52 may control the angle by determining the position of the sun with respect to a host vehicle based on season and time data and an orientation of the host vehicle.

Further, in the present embodiment, the content in which the duty ratio is changed in stages has been described with reference to FIG. 3, but the present invention is not limited thereto, and the duty ratio may be changed continuously. In addition, in the failure avoidance control, only one of the duty ratio control and the rotation control of the concave mirror 30 may be performed.

In the third embodiment, the concave mirror 30 is returned before the indicator 10 is turned on, but the present invention is not limited thereto, and the indicator 10 may be turned on before the concave mirror 30 is returned. That is, the upper limit of the duty ratio may be set to A % when the temperature of the indicator 10 decreases to C degree Celsius, and the concave mirror 30 may be returned when the temperature decreases to D degree Celsius. Here, when the indicator 10 is turned on, the temperature of the indicator 10 increases, and the predicted temperature of the indicator 10 may change back and forth several times around C degree Celsius. In such a case, the indicator 10 is repeatedly turned on and off, but even if the concave mirror 30 is not returned and is repeatedly turned on and off, this can be prevented from being noticed by the driver.

Here, features of the embodiments of the head-up display device according to the present invention described above are briefly summarized and listed below in (1) to (8).
(1) A head-up display device (1) including:
   an indicator (10) dimmed by duty ratio control and configured to emit display light;
   a mirror member (concave mirror 30) rotatable about a rotation shaft and configured to reflect the display light from the indicator to project a display image;
   a control unit (control board 50) configured to control the dimming of the indicator by the duty ratio control and control the rotation of the mirror member; and
   a temperature sensor (60) provided outside a path of the display light emitted from the indicator and configured to output a signal corresponding to an ambient temperature around the indicator, wherein
   the control unit includes:
      a temperature prediction unit (51) configured to predict, based on a duty ratio of the indicator and the ambient temperature based on the signal from the temperature sensor, a temperature of the indicator, and
      a failure avoidance unit (52) configured to execute, as failure avoidance control, at least one of lowering control for lowering an upper limit of the duty ratio of the indicator or rotation control of the mirror member for reducing the amount of sunlight that enters the indicator through the mirror member when the temperature of the indicator predicted by the temperature prediction unit is greater than or equal to a threshold.
(2) The head-up display device according to the above (1), wherein
   when the temperature of the indicator predicted by the temperature prediction unit is greater than or equal to the threshold, the failure avoidance unit lowers the upper limit of the duty ratio of the indicator as the temperature of the indicator increases.
(3) The head-up display device according to the above (1) or (2), wherein
   when the temperature of the indicator predicted by the temperature prediction unit is greater than or equal to a specified value exceeding the threshold, the failure avoidance unit (52) lowers the upper limit of the duty ratio of the indicator to zero to turn off the indicator, and rotates the mirror member to a first rotation angle at which the amount of sunlight that enters the indicator through the mirror member is less than or equal to a predetermined amount of light.
(4) The head-up display device according to the above (1), wherein
   when the temperature of the indicator predicted by the temperature prediction unit is greater than or equal to the threshold, the failure avoidance unit (52) executes failure avoidance control in which the upper limit of the duty ratio of the indicator is lowered to zero to turn off the indicator, and the mirror member is rotated to a first rotation angle at which the amount of sunlight that enters the indicator through the mirror member is less than or equal to a predetermined amount of light.
(5) The head-up display device according to the above (3), wherein
   when the temperature of the indicator predicted by the temperature prediction unit is less than the specified value from the state in which the temperature of the indicator predicted by the temperature prediction unit is greater than or equal to the specified value, and the indicator is turned off and the mirror member is rotated to the first rotation angle, the failure avoidance unit (52) executes restriction release control, which is at least one of lighting control for lighting the indicator or return control for returning the mirror member to a second rotation angle before the first rotation angle is set.
(6) The head-up display device according to the above (5), wherein
   when the lighting control is executed, the failure avoidance unit (52) increases the upper limit of the duty ratio of the indicator as the temperature of the indicator predicted by the temperature prediction unit decreases.
(7) The head-up display device according to any one of the above (1) to (6), wherein
   the temperature prediction unit (51) predicts the temperature of the indicator based on the ambient temperature detected by the temperature sensor and a heat generation amount obtained based on the duty ratio and a lighting time of the indicator.
(8) A head-up display device (1) including:
   a liquid crystal display (indicator 10) including a backlight dimmed by duty ratio control and configured to emit display light;
   a reflecting mirror (20) configured to reflect the display light from the liquid crystal display;
   a concave mirror (30) rotatable about a rotation shaft and configured to reflect the display light from the reflecting mirror toward a windshield of a vehicle to project a display image onto the windshield;
   a control unit (control board 50) configured to control the dimming of the liquid crystal display by the duty ratio control and control the rotation of the concave mirror; and
   a thermistor (temperature sensor 60) provided outside a path of the display light emitted from the liquid crystal display and configured to output a signal according to an ambient temperature around the liquid crystal display, wherein
   the control unit includes:
      a temperature prediction unit (51) configured to predict a temperature of the liquid crystal display by adding a temperature rise value obtained based on a duty ratio of the liquid crystal display to the ambient temperature based on the signal from the thermistor, and
      a failure avoidance unit (52) configured to execute lowering control for lowering an upper limit of a duty ratio of the backlight when the temperature of the liquid crystal display predicted by the temperature prediction unit is greater than or equal to a threshold, and execute rotation control of the concave mirror for reducing the amount of sunlight that enters the liquid crystal display through the reflecting mirror and the concave mirror when the temperature of the liquid crystal display predicted by the temperature prediction unit is greater than or equal to a specified value exceeding the threshold.

Although various embodiments have been described above with reference to the drawings, it goes without saying that the present invention is not limited to these examples. It is apparent that those skilled in the art can come up with various modifications or corrections within the scope of the claims, and it is understood that the modifications or corrections naturally fall within the technical scope of the present invention. In addition, the components described in the above embodiments may be combined freely without departing from the spirit of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A head-up display device comprising:
an indicator dimmed by duty ratio control and configured to emit display light;
a mirror member rotatable about a rotation shaft and configured to reflect the display light from the indicator to project a display image;
a control unit configured to control the dimming of the indicator by the duty ratio control and control the rotation of the mirror member; and
a temperature sensor provided outside a path of the display light emitted from the indicator and configured to output a signal corresponding to an ambient temperature around the indicator, wherein
the control unit includes:
a temperature prediction unit configured to predict, based on a duty ratio of the indicator and the ambient temperature based on the signal from the temperature sensor, a temperature of the indicator, and
a failure avoidance unit configured to execute, as failure avoidance control, at least one of lowering control for lowering an upper limit of the duty ratio of the indicator or rotation control of the mirror member for reducing the amount of sunlight that enters the indicator through the mirror member when the temperature of the indicator predicted by the temperature prediction unit is greater than or equal to a threshold, and wherein
when the temperature of the indicator predicted by the temperature prediction unit is greater than or equal to the threshold, the failure avoidance unit lowers the upper limit of the duty ratio of the indicator as the temperature of the indicator increases.

2. The head-up display device according to claim 1, wherein
when the temperature of the indicator predicted by the temperature prediction unit is greater than or equal to a specified value exceeding the threshold, the failure avoidance unit lowers the upper limit of the duty ratio of the indicator to zero to turn off the indicator, and rotates the mirror member to a first rotation angle at which the amount of sunlight that enters the indicator through the mirror member is less than or equal to a predetermined amount of light.

3. The head-up display device according to claim 2, wherein
when the temperature of the indicator predicted by the temperature prediction unit is less than the specified value from the state in which the temperature of the indicator predicted by the temperature prediction unit is greater than or equal to the specified value, and the indicator is turned off and the mirror member is rotated to the first rotation angle, the failure avoidance unit executes restriction release control, which is at least one of lighting control for lighting the indicator or return control for returning the mirror member to a second rotation angle before the first rotation angle is set.

4. The head-up display device according to claim 3, wherein
when the lighting control is executed, the failure avoidance unit increases the upper limit of the duty ratio of the indicator as the temperature of the indicator predicted by the temperature prediction unit decreases.

5. The head-up display device according to claim 1, wherein
the temperature prediction unit predicts the temperature of the indicator based on the ambient temperature detected by the temperature sensor and a heat generation amount obtained based on the duty ratio and a lighting time of the indicator.
